(19) United States
(12) Patent Application Publication
(10) Pub. No.: US 2005/0172242 A1
(43) Pub. Date: Aug. 4, 2005

(54) Generating a user interface

(75) Inventors: Christopher Vienneau, Montreal (CA); Michiel Schriever, Montreal (CA)

Correspondence Address: GATES & COOPER LLP;HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/039,524

(22) Filed: Jan. 19, 2005

(30) Foreign Application Priority Data
Jan. 31, 2004 (GB) 04 02 175.4

(51) Int. Cl. G06F 3/00

(52) U.S. Cl. 715/801

(57) ABSTRACT

An apparatus and a method for generating a non-modular user interface are disclosed. The user interface is composed of layers (1701 to 1703) of user interface groups (201 to 204). The groups are assigned to layers (902) and their locations are optimized (903) so that their contents, including button icons (208 to 210) retain their relative spacing regardless of the aspect ratio of the monitor (102, 1101) on which they are displayed. This ensures that familiar interface operations can be performed efficiently on systems having monitors of different aspect ratios.

### CROSS-REFERENCE TO RELATED APPLICATION

This application claims the benefit under 35 U.S.C. §119 of the following co-pending and commonly assigned foreign patent application, which application is incorporated by reference herein:

United Kingdom Application No. 04 02 175.4 entitled “GENERATING A USER INTERFACE”, by Christopher Vienneau and Michiel Schriever, filed on Jan. 31, 2004.

### BACKGROUND OF THE INVENTION

1. Field of the Invention

The present invention relates to generating a user interface. In particular it relates to generating a user non-modular interface for improved user interaction.

2. Description of the Related Art

User interfaces for the majority of computer applications use displayed visual icons to represent familiar functionality on a computer monitor. A cursor is positioned over the icon using an input device such as a computer mouse or graphics tablet with stylus. The functionality represented by the icon is activated by pressing a button on the mouse or stylus, or by briefly tapping the stylus on the surface of the graphics pad. Large numbers of icons can be displayed, providing immediate access to a considerable range of functions in a wide variety of applications, ranging from word processing to image processing and digital film editing and compositing.

A known problem with such interfaces is that the position and appearance of icons can vary between applications, even when the functionality is identical. For example, a copy function, applicable to a wide variety of media types, may have an icon that appears in a different position on the display for each of several applications. As a result, many users still navigate through a slower system of menus, while experts tend to learn keyboard shortcuts. However, for some applications the number of functions available is so great that neither menus nor keyboard shortcuts can provide a sufficient alternative to an icon-based display.

In the field of image processing, and in particular, professional image compositing for video or film, there is a large number of such functions required. It has become necessary, therefore, to adopt a style of user interface design known as a non-modular interface. In a non-modular interface, resizable application windows are not used. Resizable windows are the specific cause of icon repositioning that interferes with familiarization. Instead, in a non-modular interface, icons are placed in specific locations on the display. An operator, or graphical artist, is able to navigate such programs with great speed, because a muscle memory is built up over days and weeks of operation with the same consistent interface. This results in an extremely efficient and productive workflow.

However, in the image compositing arts, two different types of visual display are commonly used, having different aspect ratios of 16:9 and 4:3 respectively. Artists often have to switch between systems having different monitor types. Layout of a non-modular interface utilizes the full display area. In order to accommodate all necessary functions in a familiar layout, designers of image processing applications are compelled to make adjustments to icon placing to accommodate the different monitor aspect ratios, thus negating the value of the associative muscle memory defined while using a particular monitor configuration.

### SUMMARY OF THE INVENTION

According to an aspect of the present invention, there is provided apparatus for processing image data, comprising processing means, storage means storing data and processing instructions including instructions for generating a user interface, graphical user input means for navigating said user interface and graphical display means, wherein said processing means is configured by said instructions to perform steps of defining a plurality of user-interface groups containing a plurality of user interface components, layering said groups in response to respective visibility priority levels, optimizing the location of said groups, displaying said groups on said graphical display means and analyzing signals from said graphical user input means to select an image processing operation in response to user activation of a said user interface component.

### BRIEF DESCRIPTION OF THE DRAWINGS

FIG. 1 shows an image processing workstation, including a processing system, a wide aspect ratio monitor and a graphics tablet;

FIG. 2A shows a screen shot of the monitor shown in FIG. 1, including a user interface;

FIG. 2B shows the screen shot of FIG. 2A with a player expanded to fill the screen;

FIG. 3 shows a prior art screen shot of a narrow aspect ratio monitor displaying the same interface shown in FIG. 2;

FIG. 4 details the graphics tablet shown in FIG. 1, with the user interfaces shown in FIGS. 2 and 3 superimposed upon it;

FIG. 5 details components of the processing system shown in FIG. 1, including a main memory;

FIG. 6 summarizes steps performed by the user to install and run graphics application processing instructions on the processing system shown in FIG. 1, including a step of running the application;

FIG. 7 details the step of running the application shown in FIG. 6, including a step of initializing user interface data structures;

FIG. 8 details contents of the main memory shown in FIG. 5 that result from the steps performed in FIG. 7, including a user interface graph, objects and layer data;

FIG. 9 details the step of initializing user interface data structures shown in FIG. 7, including a step of defining user interface panel data structures, a step of layering groups and a step of optimizing group locations;

FIG. 10 illustrates the effect of the steps performed in FIG. 9;

FIGS. 11 and 12 illustrate the display of the interface shown in FIG. 2 on a narrow aspect ratio monitor;

FIG. 13 details the step of defining user interface group data shown in FIG. 9;

FIG. 14 details the display area objects shown in FIG. 8;

FIG. 15 details the group objects shown in FIG. 8;

FIG. 16 details the step of layering groups shown in FIG. 9; and

FIG. 17 details the step of optimizing group locations shown in FIG. 9.

### DETAILED DESCRIPTION

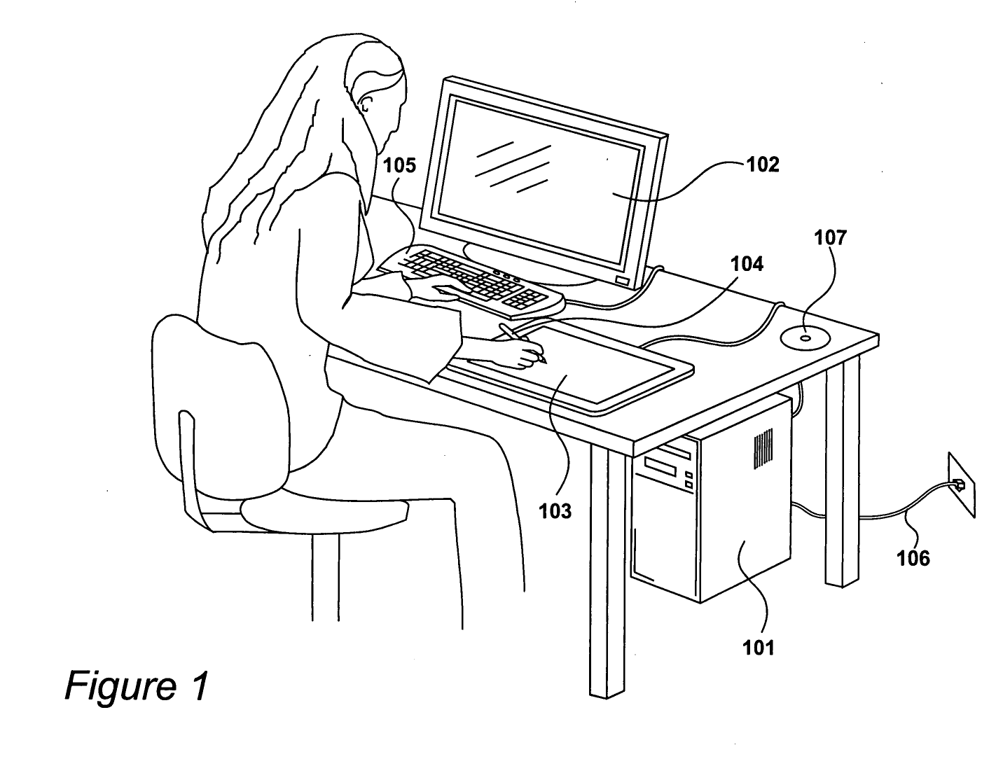

FIG. 1

A workstation for performing image processing is shown in FIG. 1. A computer or processing system 101 stores and processes image data, which is displayed on a monitor 102. Operator input is supplied via a graphics tablet 103 with stylus 104, and a keyboard 105. Image data can be received and transmitted from the processing system 101 over a network 106. Instructions for the processing system 101, in the form of a program, can be loaded from the network 106 or a CD-ROM disk 107.

The monitor 102 shown in FIG. 1 is a wide view monitor, having an aspect ratio (width to height ratio) of 16:9. Such wide view monitors have advantages in some applications, but are particularly valuable in the visual arts since much film material has these dimensions. High definition television images also have a 16:9 aspect ratio, and significantly benefit from preview on such monitors.

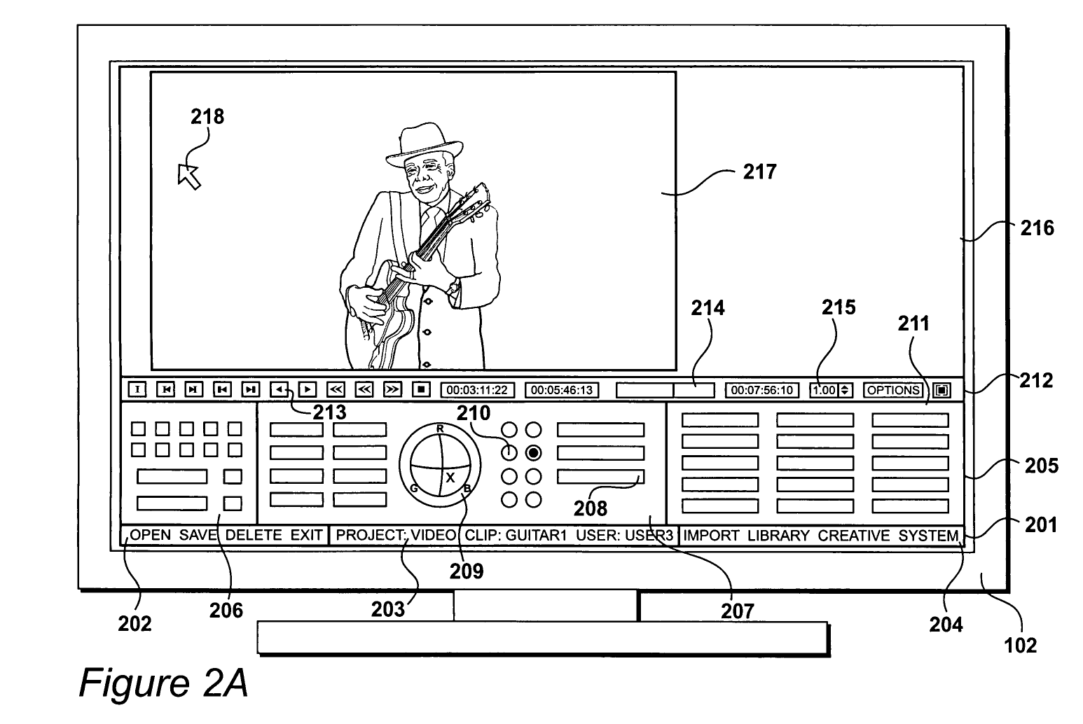

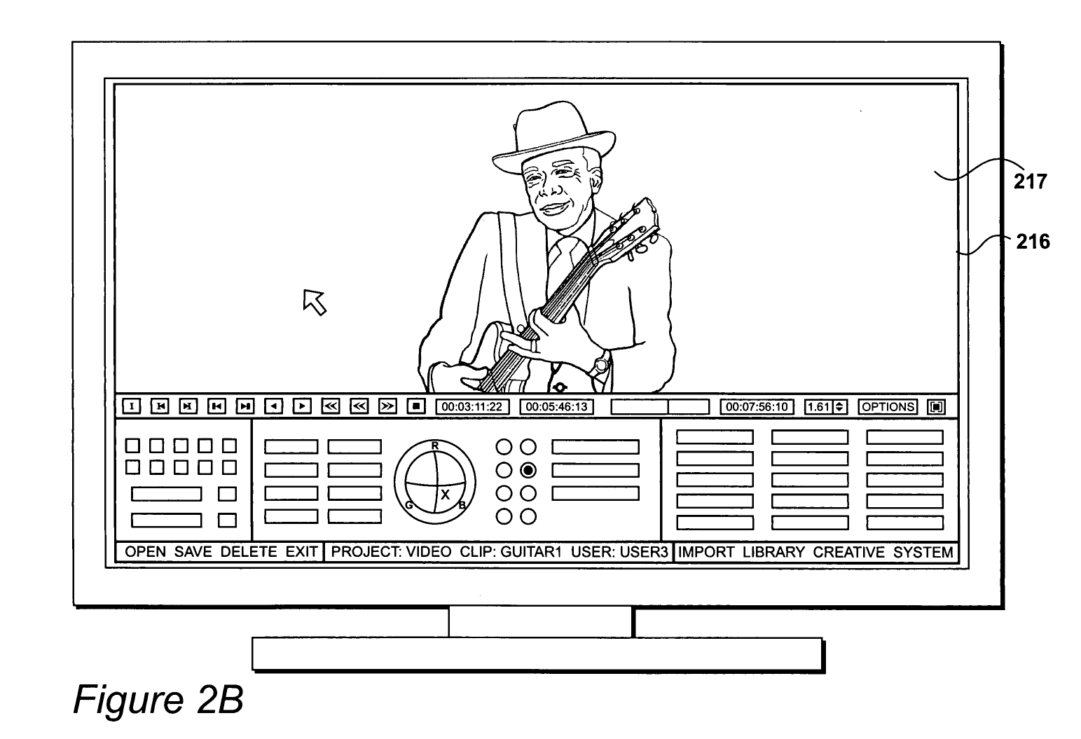

A view of the screen of the monitor 102 shown in FIG. 1 is detailed in FIG. 2. The screen contains many different kinds of groups of components, each of which is contained in a display area. At the bottom of the screen is a first display area, taskbar 201, which includes three groups called sections. Task section 202 includes buttons for tasks such as opening and saving clips and exiting the application. Information section 203 gives project, clip and user information for the currently selected clip of frames. Workspace section 204 includes buttons allowing the user to switch to other workspaces. For example, the user is currently in the Creative workspace, where “creative” work such as editing and effects takes place. Other available workspaces are concerned with more administrative tasks such as capturing image data from videotape and organizing a library of clips. Each workspace has a different display.

Also included in the view is a second display area, tool interface 205, having icons that, when selected, call particular functions to carry out the user's image processing requirements. In the example shown the user is in the Creative workspace and here an artist works on a single effect at once. The groups contained in tool interface 205 are panels. First panel 206 and second panel 207 provide a wide variety of functions for the currently-selected effect. For example, the current tool might be a color warper, in which case the panels provide text boxes such as box 208 to give numeric input for various parameters, widget 209 to give chromaticity input and radio buttons such as button 210 to select the parameter that the widget is altering. First panel 206 provides buttons that are used less often. Third panel 211 provides buttons allowing the user to change the selected effect. Thus it will be understood that an artist will be primarily using the buttons in second panel 207, secondarily using those in first panel 206, and occasionally using those in third panel 211 when he wishes to change the tool interface in order to work on a different effect.

A third display area is player controls bar 212. This comprises a single group of components, including for example play button 213, time display 214 indicating the length of the clip, zoom control 215 that controls the amount of zoom in a player window, and so on.

The remainder of the screen is taken up with fourth display area, viewer 216, which can contain a plurality of groups, which in this example are players. (This is an example of a group that does not contain any further components—the word group should not be construed to include only containers of components but means any displayed item within a display area.) FIG. 2A shows a single player 217, which displays the entire image. FIG. 2B shows the same player in which the image has been zoomed using zoom control 215 in order to work on a part of the frame at a higher resolution. Tool interface 205, player controls bar 212 and taskbar 201 are superimposed either opaquely or transparently on the viewer 216, such that if a player 217 is enlarged to fill the whole screen it is overlapped by areas 201, 205, and 212. On extremely high-resolution monitors this can allow an artist to see and work on the entire image at full resolution, especially if the other areas are displayed transparently.

The graphics tablet 103 is operated by a hand-held stylus 104. The position of the tip of the stylus 104 on the graphics tablet 103 facilitates the positioning of a cursor 218 on the screen 102. When the cursor is placed over an icon, such as button 210, on the screen 102, the user can activate the functionality associated with that icon by briefly tapping the stylus tip, or pressing one of several buttons provided on the body of the stylus 104. The physical position of the stylus 104 on the graphics tablet surface 103 is represented by the position of the cursor 218 with respect to the screen area.

After many hours of use, the artist becomes accustomed to the relative positioning of the many buttons provided on the user interface, particularly those that are most frequently accessed. As a result, any change in the size or relative positioning of buttons within the tool interface 205 on the screen 102 can result in considerable reduction in workflow.

A similar consideration applies for the other displays within the application, as accessed by the buttons in workspace section 204 of taskbar 201. In each of these there is a tool interface that includes a plurality of panels, each of which should have icons and buttons that do not move in order to improve an artist or user's muscle memory.

A typical image-processing environment may include several workstations of the type shown in FIG. 1. However, a 16:9 full resolution monitor is expensive and so monitors having different aspect ratios will also be used. These may be used by the same artist running the same image processing application, by another user who is loading and archiving material for an artist or by an artist who is working on a less important job or working with images of a lower resolution. Movement between different workstations is necessary, because less well equipped workstations are often used to prepare material for more intensive work on a more expensive workstation, thereby using processing resources most efficiently. However, preparation work still requires efficient navigation of the same user interface elements. The skilled reader will understand that although only the popular 16:9 and 4:3 monitor sizes are referred to here, there are in fact many aspect ratios that can be used and the invention applies to any of them.

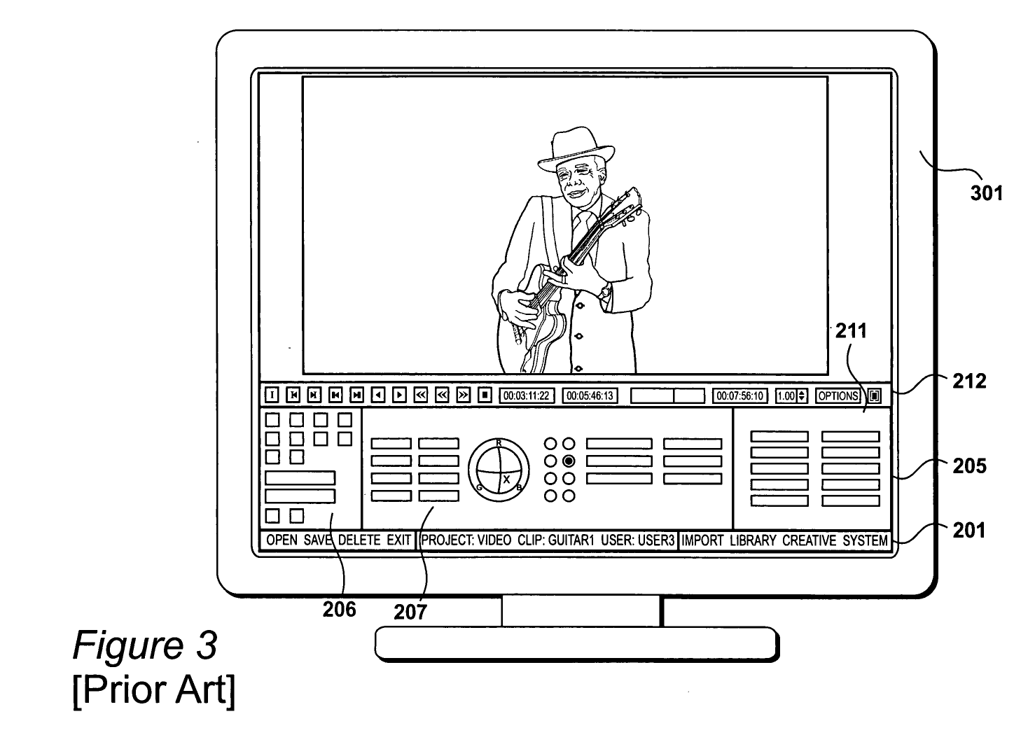

FIG. 3

A prior art view of the interface shown in FIG. 2 is shown in FIG. 3. In FIG. 3, the same interface has been compressed horizontally to fit the dimensions of a monitor 301 having a 4:3 aspect ratio as opposed to the 16:9 aspect ratio of the monitor 102 shown in FIG. 2. The non-modular interface is accommodated by horizontally scaling the groups within the display areas 201, 205 and 212 by seventy-five percent. However, the individual button icons are now displayed differently. The buttons in taskbar 201 and in player control bar 212 have simply been shrunk horizontally, the buttons in panels 207 and 211 have been shrunk in both dimensions and the buttons in panel 206 have been completely rearranged while keeping their original size.

Any of these changes to the layout of icons results in changes in the distances between the points on the graphics tablet that represent these buttons and icons. Thus a change of physical stylus movement is required for the same activation of frequently used button icons. A conflict therefore exists between the requirement to provide all the required functions and the requirement to avoid changing relative icon positioning.

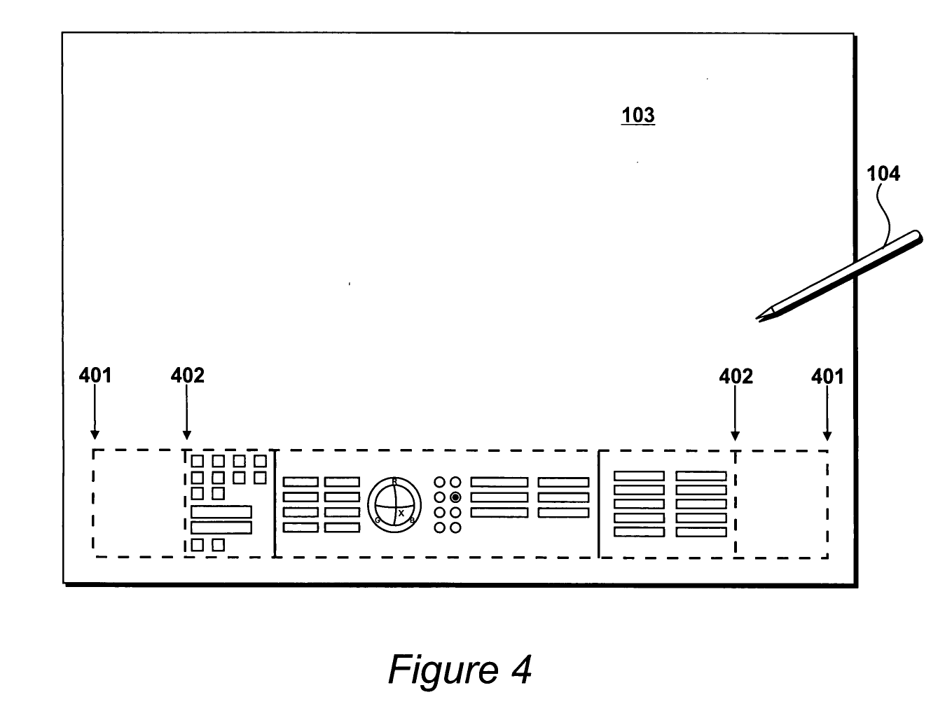

FIG. 4

The effect that the monitor aspect ratio has on positioning is demonstrated in FIG. 4, which shows the surface of the graphics tablet 103 with the tool interface 205 at both aspect ratios superimposed upon it at 401 and 402. The 16:9 ratio provides normal navigation across the full width 401 of the 16:9 display. However, when this is compressed by the necessary seventy-five percent to the smaller width 402, the relative positioning of the interface components within each panel is changed.

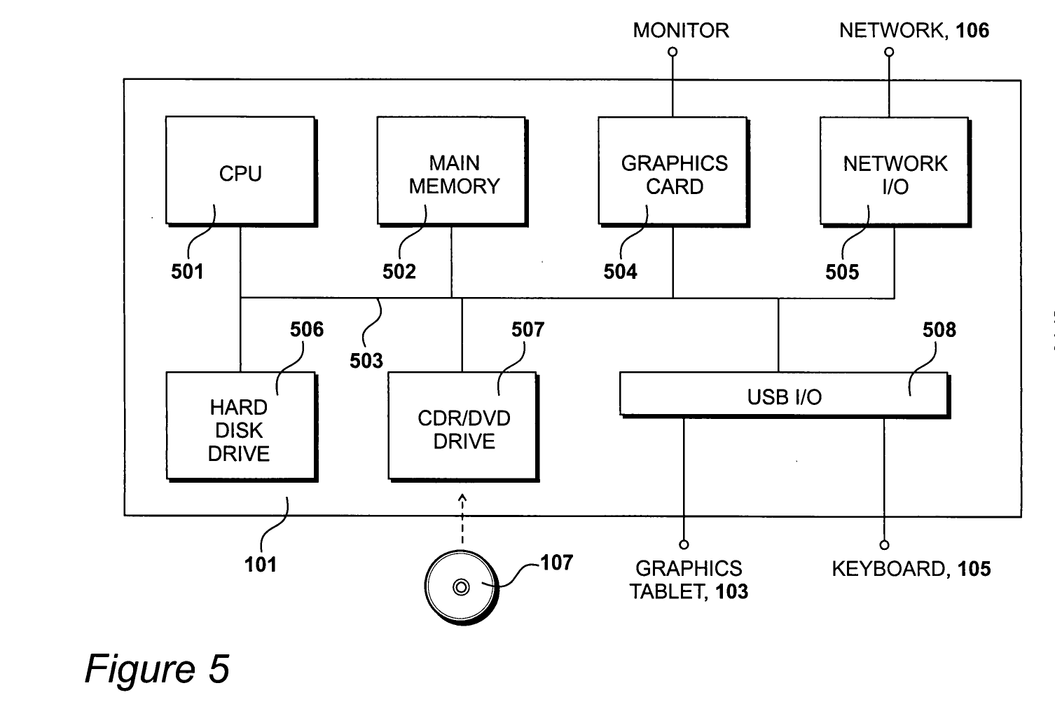

FIG. 5

The processing system 101 shown in FIG. 1 is detailed in FIG. 5. A Pentium™ IV Central Processing Unit (CPU) 501 receives processing instructions from a main memory 502, comprising five hundred and twelve megabytes (MB) of random access dynamic memory (RAM). Processing performed by the processor 501 acts upon data stored in the main memory 502 and data is transferred to and from other system components along several system busses 503. A graphics card 504 receives instructions and data generated by the processor 501 to generate image frames that are displayed upon the monitor 102, or a reduced aspect ratio monitor similar to the one shown in FIG. 3. A Network Input Output (I/O) card 505 provides communication with other processing systems connected to the network 106, and also to external networks including the Internet. Instructions and data can both be transferred via the Network I/O card 505.

A hard disk drive 506 provides non-volatile local storage of instructions and data for the processing system 101. During operation of the processing system 101, instructions and data are transferred to the main memory 502 from which repeated processing transfers can be performed at high speed. Instructions and data can be supplied to or from the network 106, or from a CD-ROM disk 107. A CD-R/DVD drive 507 accepts CD-ROM disks, from which application processing instructions can be installed onto the hard disk drive 506, or possibly onto a remote application server on the network 106. A Universal Serial Bus (USB) I/O circuit 508 provides connectivity between the processing system 101 and the graphics tablet 103, and the keyboard 105. Input signals from these devices are interpreted according to instructions running on the processor 501, resulting in appropriate selection of image processing operations being performed upon various data.

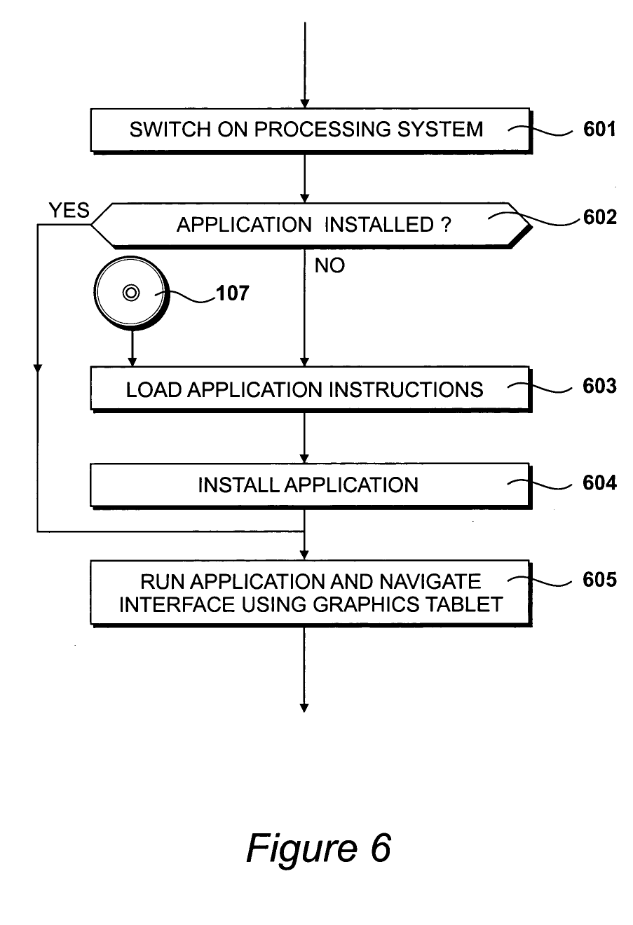

FIG. 6

User operations for initializing the processing system 101 shown in FIG. 1 are summarized in FIG. 6. At step 601 the processing system 101 is switched on. At step 602 a question is asked as to whether the image processing application is installed. If the application is already installed, control is directed to step 605. If the application does need to be installed, control is directed to step 603 where the image processing application is loaded from the CDROM disk 107. At step 604, the application is installed by running installation instructions. At step 605 the application instructions are run, and the user interacts with the application instructions by navigating the interface shown on the monitor 102 or 301 using the graphics tablet 103.

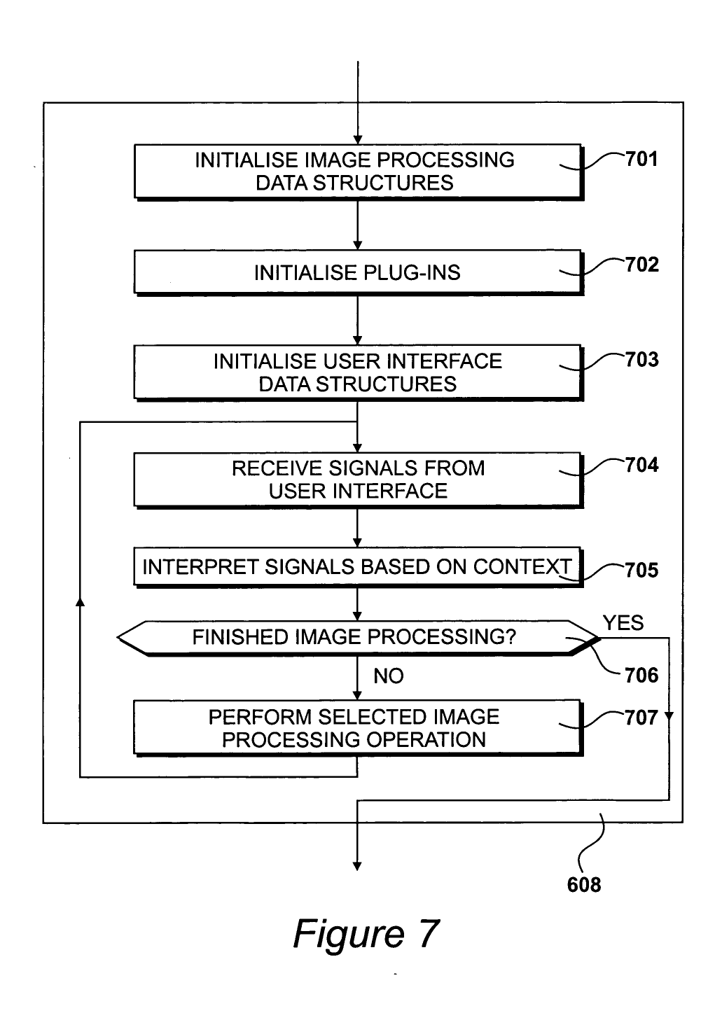

FIG. 7

The step 605 of running the image processing application shown in FIG. 6 is detailed in the flow chart shown in FIG. 7. At step 701 data structures used by the image processing application are initialized. At step 702 plug-ins are initialized. Plug-ins are add-on sequences of processor instruction modules that perform commonly used operations, such as conversion between image formats like JPEG, MPEG and TIFF. Other types of plug-in modules provide various types of special effects, such as lighting, color warping, grain effects and blur filters.

At step 703 data structures used for the user interface of the application are initialized. Steps 701, 702 and 703 perform initialization of the image processing application, resulting in the display of the interface as shown in FIG. 2, when viewed on a 16:9 aspect ratio monitor. Steps 704 to 707 represent repeated steps that are performed during the running of the application instructions. At step 704, signals are received from the graphics tablet 103 in conjunction with context data defining the position of the cursor 218 with respect to user interface components such as icons 208, 209 and 210. At step 705 the signals are interpreted based upon this context. At step 706 a question is asked as to whether the user has signaled, via the user interface, that image processing is finished. If so, this completes the steps for running the image processing application. Alternatively, control is directed to step 707, where a user-selected image processing operation is performed. Thereafter, control is directed back to step 704. The skilled reader will realize that the steps 704 to 707 for running the application can be implemented as multi-thread or multi-process instructions, possibly running in parallel on one or several multi-tasked processors or processing systems.

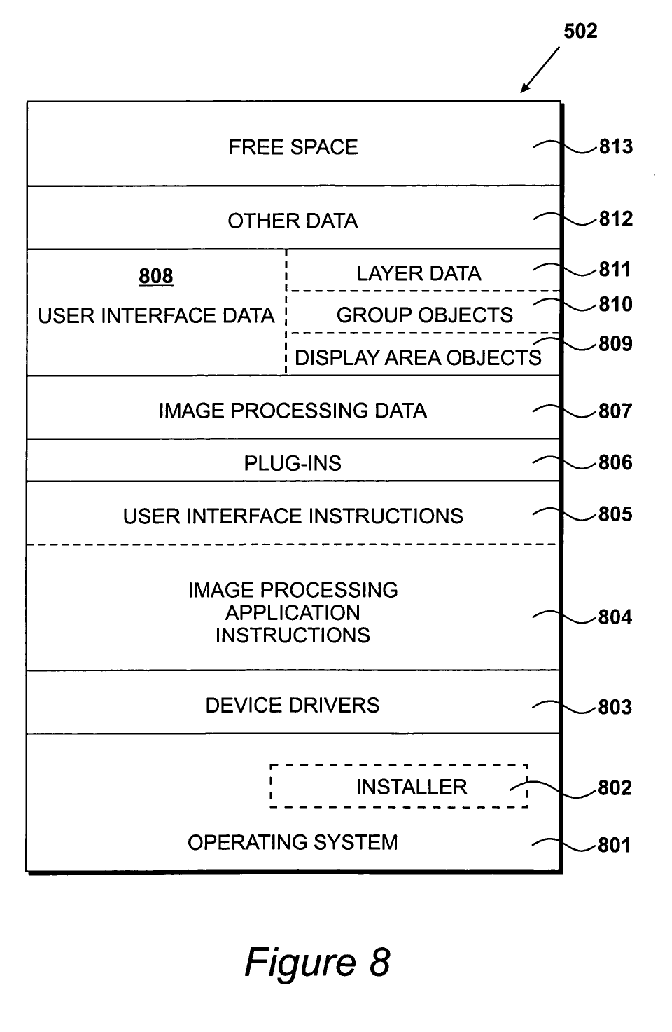

FIG. 8

As a result of running the application, the contents of the main memory 502 shown in FIG. 5 are as detailed in FIG. 8. An operating system 801 provides processor instructions for common functionality, such as the ability to allocate portions of main memory 502 in response to the demands of application processes. The operating system 801 is a Windows™ NT 4.0 operating system, although alternatives including the Linux™ operating system are increasingly used in image processing workstations. The operating system 801 includes installation instructions 802 for installing the image processing application, or other applications, onto the hard disk drive 506. Device driver instructions 803 provide hardware abstraction for the operating system 801, so that operating system processing instructions can be executed in the same way on workstations of widely varying hardware. For example, device driver abstraction makes it possible for the operating system 801 to treat monitors having different aspect ratios similarly. Information about the dimensions of the monitor are, however, available to an application if an explicit request is made by the application for this information.

Image processing application instructions 804, having commenced execution at step 605 in FIG. 6, reside in main memory 502 so as to facilitate user-intended image processing operations upon image data. Image processing instructions include user interface instructions 805, so that user-directed activation of an interface, such as that shown in FIG. 2, will result in appropriate processing actions being performed upon image data.

Plug-ins 806 provide some of the functionality used by the image processing instructions 804. Typically, image-processing operations upon image data are performed by instructions provided as part of the main image processing application 804 or as one of several plug-ins 806. Image processing data 807 stores image data upon which some form of processing is being performed. In advanced image processing, image-processing data may also include cached image frames that have been fetched from the hard disk drive 506 or from remote storage on the network 106. Such caching anticipates image frame requests, thereby reducing the time taken to download large amounts of image data.

User interface data 808 includes data structures used to present the interface shown in FIG. 2, and which can also facilitate improved display on monitors of different aspect ratios. User interface data structures include display area objects 809, group objects 810 and layer data 811. Other data 812 used by the processing system includes data structures used by the operating system. Free space 813 varies significantly in response to varying processing demands made in response to user operations and also by calls made to the operating system by the application that result in allocation or freeing of main memory portions.

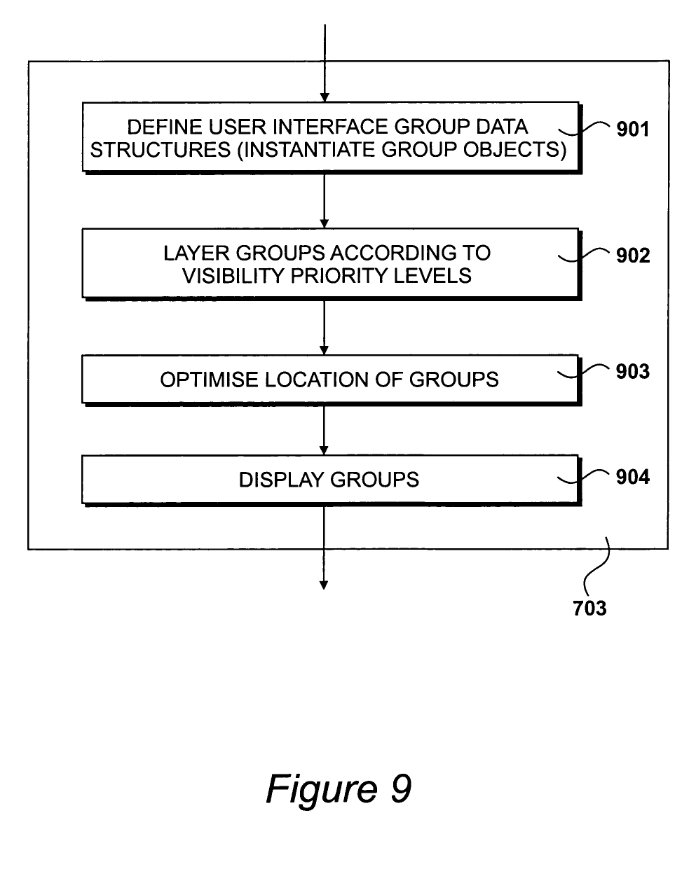

FIG. 9

The process of initializing user interface data structures, shown at step 703 in FIG. 7, is detailed in FIG. 9. At step 901 user interface group data structures are defined. This is achieved by instantiating a group several times, once for each user interface group that is required. Groups are areas of the user interface that are displayed according to strict criteria in a non-modular user interface; in this embodiment panels, sections and player windows are all groups. At step 902, the user interface groups are layered according to their respective visibility priority levels. At step 903 the location of the groups is optimized for the characteristics of the display area upon which the groups are to be displayed. At step 904, the user interface groups are displayed.

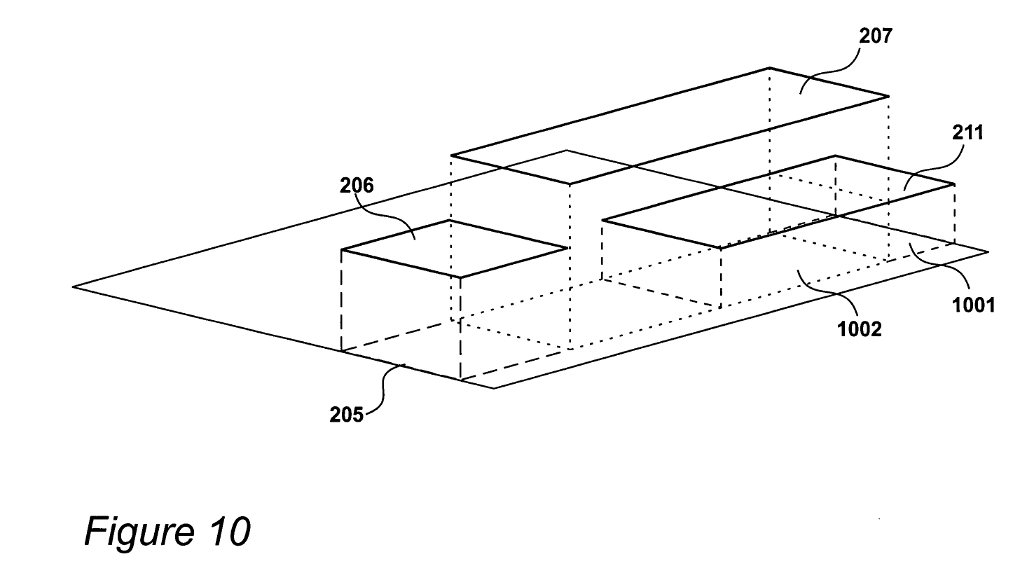

FIG. 10

The effect of user interface data structures initialized in FIG. 9 is illustrated in FIG. 10. The user interface is constructed in several layers, and is shown having dimensions that are used for displaying the interface on a monitor having a 4:3 aspect ratio. For example, the tool interface 205 comprises three panels, 206, 207 and 211. Central panel 207 is on a higher layer than side panel 206, which in turn is on a higher layer than side panel 211. The dimensions of these three panels have not been changed as a result of display on a 4:3 aspect ratio monitor, with the result that all three panels cannot fit on the monitor. As the panel with the lowest visibility priority level, panel 211 is overlapped by central panel 207. Thus side panel 211 has a visible area 1001 and a concealed area 1002.

Central panel 207 can be moved from side to side, in order to reveal more of the underlying side panels if necessary. If the user moves panel 207 to the left then it will also overlap side panel 206, since it has a higher visibility priority level. A user may at any time reveal a low-priority panel, but on returning to default mode a higher-priority panel will always overlap a lower-priority panel.

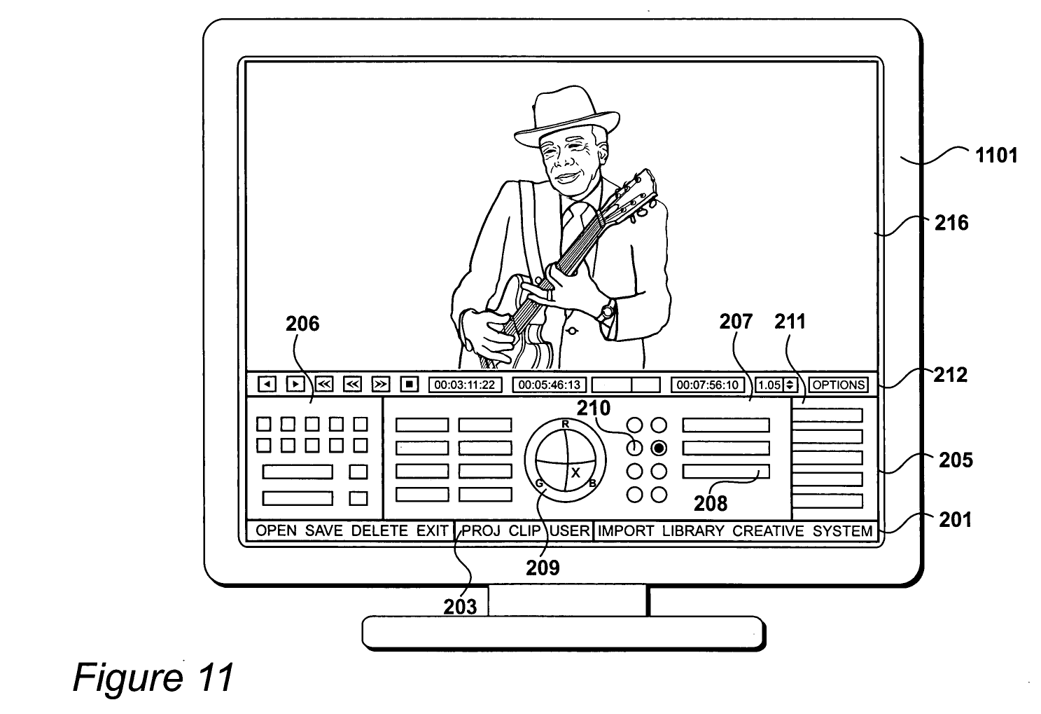

FIG. 11

The result of displaying the user interface groups performed at step 904 in FIG. 9 is illustrated in FIG. 11. The 16:9 aspect ratio monitor 102 shown in FIG. 1 has been replaced by a 4:3 aspect ratio monitor 1101. Instead of reducing the size of panels 206, 207 and 211, panel 207 has been layered over the top of panel 211. This means that the relative spacing of the user interface components, for example components 208, 209 and 210 on second panel 207, is the same as for the 16:9 monitor shown in FIG. 2. This contrasts with the display of user interface components on the same section of the user interface shown in FIG. 3. As a result, frequently used functions can be accessed by an artist on monitors of different aspect ratio while maintaining the same relative positioning of user interface components, and thereby avoiding the need to adjust or re-learn muscle-memory for a particular interface.

Although paneling could equally be used for taskbar 201, instead the text in information section 203 has been truncated to allow the shrinking of section 203. This is possible because this section only provides information and not buttons and therefore is not often used. The entirety of the text can be seen by hovering cursor 218 over the truncated text.

The scaling of player controls 212 has been achieved by omitting some of the buttons that are less frequently used. Different sets of buttons will be displayed depending upon whether the tool interface is displaying tools relevant to effects or to editing. Thus all of the buttons are still the same size.

Viewer 216 also contains groups. For example, it may contain more than one player, or may contain a browser of clips. The player containing the images being worked on will always be the top layer and the browser will always be the bottom layer. As a whole, the viewer is the bottom layer of the screen, since if the player is expanded to fill the screen the other display areas are layered on top of it. However, they can be a transparent layer. Transparent layers are generated by instructing the graphics card 504 that a panel is to be rendered transparently. The graphics card 504 then renders the final image by combining rendered pixel values from a plurality of overlapping groups on two or more different layers.

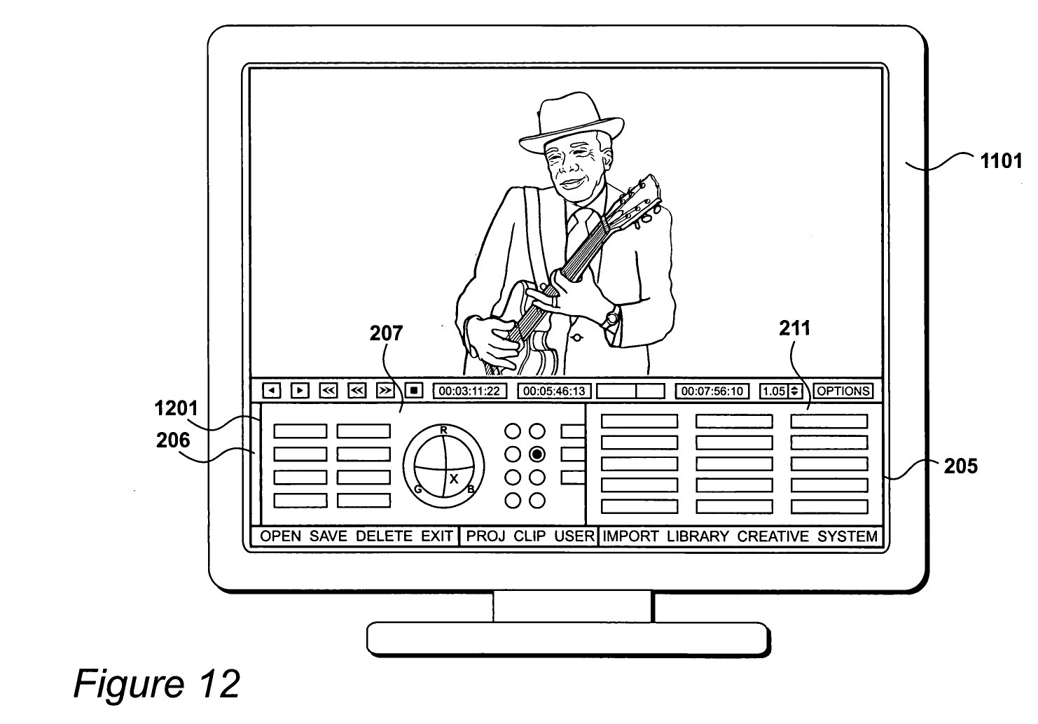

FIG. 12

When necessary, more rarely used functions provided by the side panel 211 can be accessed either by sliding the central panel 207 to the left or by indicating that panel 211 should overlap panel 207 instead of being overlapped. This is illustrated in FIG. 12. The sliding operation is achieved by positioning the cursor 218 over the left border 1201 of the central panel 207, pressing and holding the button on the stylus 104, dragging the panel to the left and then releasing the stylus button. No panel, however, is permitted to completely overlap any other panel and thus there is still a visible area of first panel 206. This is in order that the border of an overlapping panel can be distinguished from that of an overlapped panel so that the user can select and move the required border.

It is not possible for the user to create unused spaces and so the leftmost and rightmost panels 206 and 211 are not slidable. For the same reason, panel 207 as shown in FIG. 11 cannot be moved to the right since the entirety of panel 206 to its left is already exposed. (However, once it has been moved to the left as shown in FIG. 12 it can be moved back to its original position by dragging a border to the right.) Movement of panels when the application is displayed on a 16:9 monitor is not permitted (or necessary).

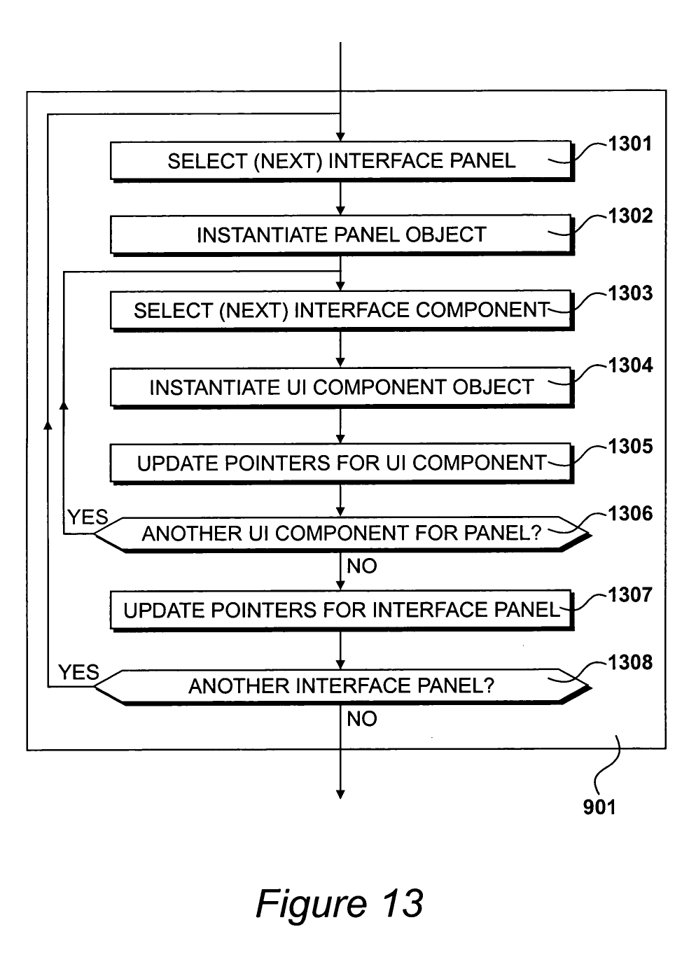

FIG. 13

The process of defining user interface group data structures, performed at step 901 in FIG. 9, is detailed in FIG. 13. At step 1301 the first interface group 201 is selected. At step 1302 a group object is instantiated, resulting in the allocation of memory by the operating system 801 and population of the data structure for the object. Steps 1303 to 1305 populate the group with various user interface components, such as view windows, buttons, menus and so on. At step 1303 the first user interface component for the group is selected. At step 1304 the respective user interface component object is instantiated. At step 1305 pointers linking the user interface component to the group are updated. At step 1306 a question is asked as to whether another user interface component is needed for the group. If so, control is directed to step 1303, and steps 1303 to 1306 are repeated until all components for the currently selected group have been instantiated.

At step 1307 pointers from the interface group object are updated, linking it to its parent elements in the user interface data structure. At step 1308 a question is asked as to whether another interface group is needed. If so, control is directed to step 1301. Alternatively, once all groups and their constituent interface components have been created, this completes the definition of user interface group data.

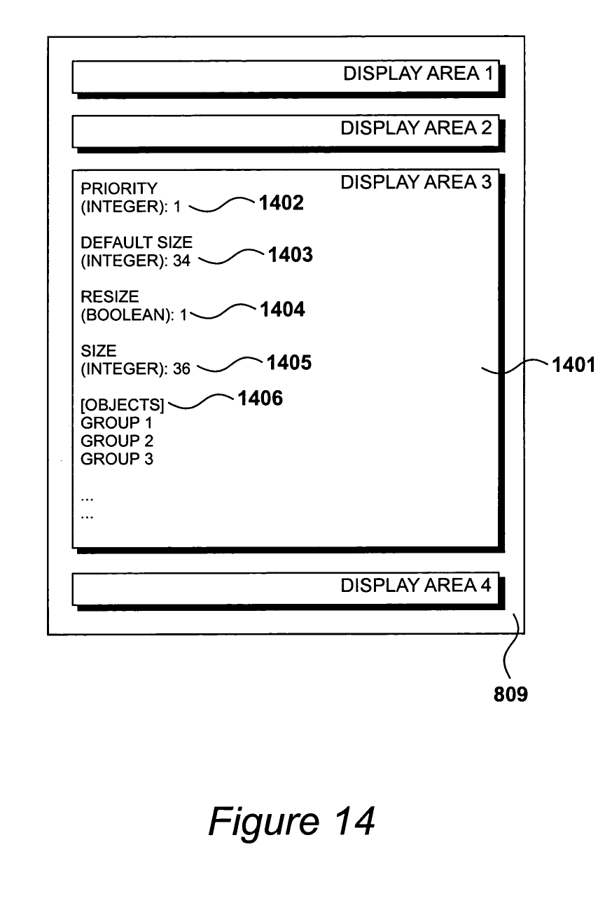

FIG. 14

Display area objects 809 as shown in FIG. 8 and generated according to the steps shown in FIG. 13 are shown in FIG. 14. Each display area has a number of attributes, some of which are shown here. Only display area object 1401 is shown in detail.

Priority attribute 1402 gives the priority level of the area. In this example, the player controls bar 212, the tool interface 205 and the taskbar 201 all have equal first priority, with the viewer 216 having a lower priority. This means that when player 217 is increased in size it is always layered underneath the other areas.

Default size attribute 1403 indicates the default vertical size of the area, expressed as a number of units. In this embodiment a unit is eight pixels. Thus display area two, which corresponds to tool interface 205, has a default height of thirty-four units. This is not dependent upon the size of the monitor. Resizing attribute 1404 indicates that the height of the tool interface 205 can be changed if the user wishes and thus actual size attribute 1405 gives the actual size of the area; this attribute is changed whenever the user resizes an area. In this example, the tool interface been resized to be thirty-six units high. At any time the user may set the height of an area to be equal to its default size. In this embodiment the player controls 212 and taskbar 201 have a set height in units and are not vertically resizable. The size of viewer 216, however, is not expressed in units but is the same as the height of the monitor. This means that when switching to a monitor with a larger vertical pixel size the viewer scales up but the other display areas do not, thus assisting the user to develop muscle memory independently of the aspect ratio or size of the monitor. Thus the only visible difference (vertically) is that the viewer is larger.

In this embodiment each display area has the same width as the width of the monitor and so the horizontal size need not be specified. Further attributes are not shown but specify, for example, the vertical alignment of the area, the colors of the area, the type of border it has and so on.

Each display area additionally lists the groups it contains. Lines 1406 show that display area two, which corresponds to tool interface 205, contains three groups, corresponding to panels 206, 207 and 211. Similarly, the viewer 216 contains players, the player controls bar 212 contains packs of controls and the taskbar 201 contains sections. These are all called groups since they tend to group together interface components of some sort, such as buttons, widgets, information bars or controls.

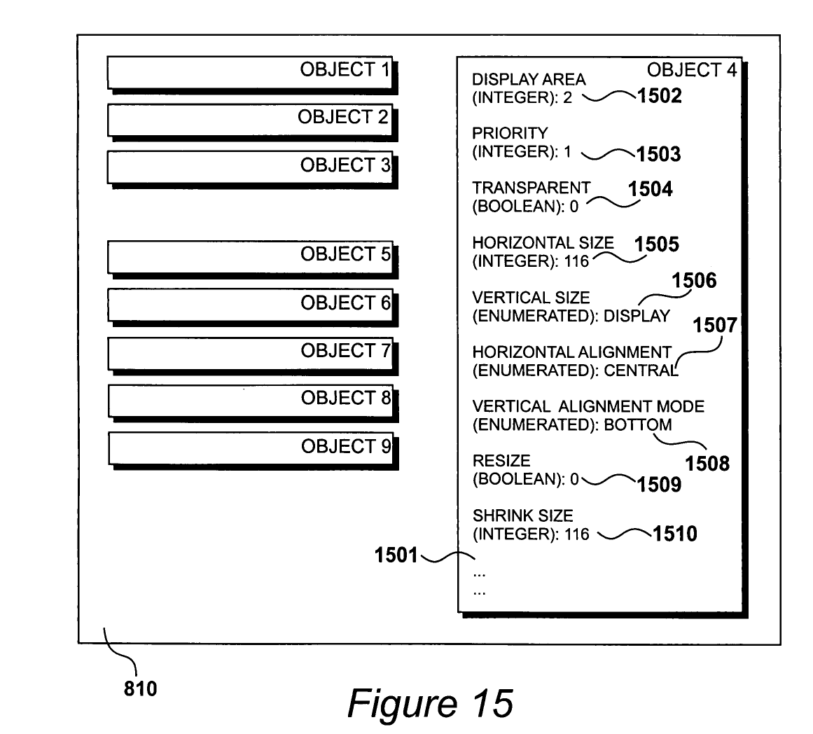

FIG. 15

FIG. 15 shows group objects data 810 as shown in FIG. 8 and generated according to the steps shown in FIG. 13. Similarly to the display area objects 809, each group has a number of attributes stored in various data formats. The group object corresponding to panel 207 of tool interface 205 is shown in detail at 1501.

A display area attribute 1502 is stored as an integer and defines the display area of the screen in which the group is displayed. A visibility priority level 1503 is stored as an integer, and is used to define the layer upon which the panel is to be displayed. A transparency flag 1504 defines whether or not the panel is to be rendered transparently. (This attribute is user-controlled.) The width of the group is stored as an integer at attribute 1505, which in this example is thirty-nine units, while the height is stored either, as at line 1506, as a value indicating that it is equal to the height of the display area or, as is the case with a player in the viewer area, as an integer.

A horizontal alignment attribute 1507 is stored. There are four options for this attribute, namely left, right, central and an integer. For each of the display areas corresponding to the tool interface 205, player controls bar 212 and taskbar 201 there is only one left- and one right-aligned group but there may be many centrally aligned groups. However, for the viewer 216 the horizontal alignment of a player is expressed as an integer, which is user-controlled by movement of a player window. Similarly, vertical alignment mode attribute 1508 can be top, bottom, or an integer (viewer only).

Resize attribute 1509 is a boolean attribute controlling whether or not the group is user-resizable. For example, a viewer window is resizable. If this attribute is set to 1 then additional default size attributes are used, although they are not shown here. Shrink size attribute 1510 controls whether or not a group shrinks when the monitor size changes. If this size is equal to the horizontal size 1505 then the group does not shrink, but if it is smaller than horizontal size 1505 then the group shrinks but not further than the shrink size 1510. In this embodiment, none of the panels in tool interface 205 shrinks because layering is used; however, workspace section 204 in taskbar 201 shrinks.

Further attributes are not shown; in particular each group object contains a list of component objects that it contains and also specifies the type of group that it is and attributes relating to its appearance, for example colors.

Using these the interface can be structured appropriately for all monitors. This ensures that all the groups will be rendered in the correct location on monitors having any aspect ratio.

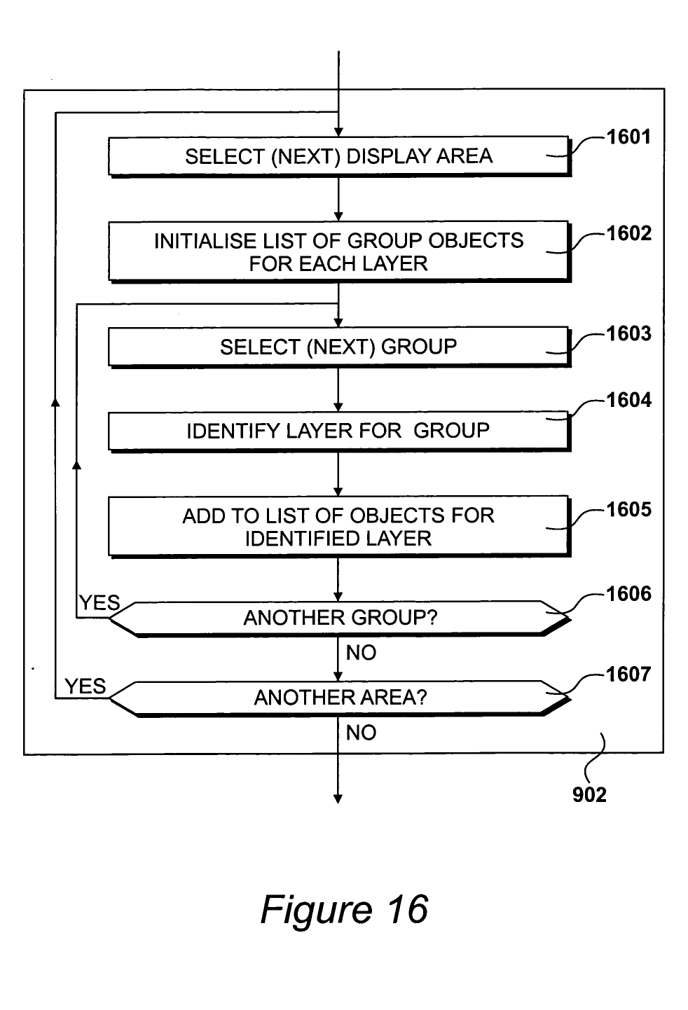

FIG. 16

The process of layering groups according to their visibility priority levels 1503, as shown at step 902 in FIG. 9, is detailed in FIG. 16. At step 1601 a first area of the display is selected. At step 1602 the list of groups for each layer for this area is initialized to contain no objects. At step 1603 the first group in the area is selected. At step 1604 the layer within the display area on which the group should be displayed is identified and at step 1605 the group is added to the list of objects for this layer. At step 1606 a question is asked as to whether another group needs to be layered. If so, control is directed back to step 1603 and the next group is selected. Once all groups have been assigned to their respective layers, a question is asked at step 1607 as to whether there is another area of the display to consider. If this question is answered in the affirmative then control is returned to step 1601 and the next area is selected, whereas if it is answered in the negative then this completes the steps required for layering groups.

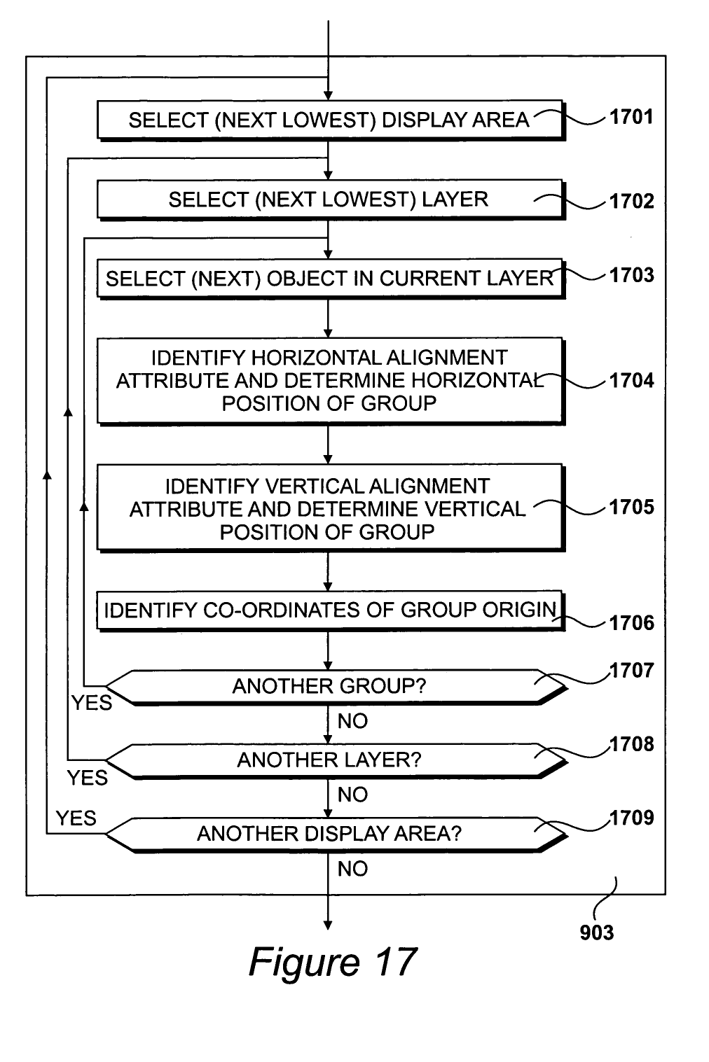

FIG. 17

The step 903 of optimizing the location of panels, shown in FIG. 9, is detailed in FIG. 17. At step 1701 the area of the display having the lowest priority is selected and at step 1702 the last layer of that area is selected. At step 1703 the first group in the currently selected layer is selected and at step 1704 its horizontal position on the monitor is calculated using the monitor size, the layer, the alignment attribute and the horizontal size of the group. It also uses the rule that a group on a higher layer covers up, if necessary, groups on lower layers, covering up the lowest layer first and so on. Thus, in this embodiment, panel 207 on the highest layer does not cover panel 206 on the second layer but does cover panel 211 on the last layer. However, if for example panels 206 and 207 were larger and panel 211 were smaller then it would be necessary for panel 207 to cover a portion of both side panels. Also, if shrink attribute 1510 is smaller than horizontal size attribute 1505 for a group then the group is shrunk before any overlapping is carried out.

At step 1705 the vertical alignment attribute 1508 is identified and the group's vertical position is calculated. At step 1706 the co-ordinates of the group's origin in pixels (its top left-hand corner) are identified using the calculated horizontal and vertical positions. At step 1707 a question is asked as to whether another group is to be selected from the currently selected layer. If so, control is directed back to step 1703 and steps 1704 to 1706 are repeated for another group. Alternatively, at step 1708 a question is asked as to whether another layer is to be considered. If so, control is directed back to step 1702, and panels from the next lowest layer are processed. If the question asked at step 1708 is answered in the negative then at step 1709 a final question is asked as to whether there is another display area to optimize. If this question is answered in the affirmative then control is returned to step 1701 and the area with the next lowest priority level is selected. Eventually all layers will have been processed, question 1709 is answered in the affirmative and the areas can be displayed at step 904 in FIG. 9, with areas of a higher priority overlapping those of a lower priority where necessary.

The skilled reader will understand that the above description refers only to an embodiment of the invention. The exact details of the objects, such as groups or taskbar sections, and their display, for example as panels, will differ from application to application.

1. An apparatus for processing image data comprising:
(a) graphical user input means for navigating a user interface;
(b) processing means,
(c) processing instructions executing on said processing means, said processing instructions configured to:
(i) generate the user interface;
(ii) define a plurality of user-interface groups containing a plurality of user interface components;
(iii) layer said groups in response to respective visibility priority levels;
(iv) optimize a location of said groups in response to an aspect ratio of a graphical display means;
(v) display said groups on said graphical display means; and
(vi) analyze signals from said graphical user input means to select an image processing operation in response to user activation of one of said user interface components.

2. The apparatus according to claim 1, wherein at least one of said groups is displayed transparently.

3. The apparatus according to claim 1, wherein at least one of said groups is movable.

4. The apparatus according to claim 3, wherein a group cannot be moved further than an edge of an adjacent group.

5. The apparatus according to claim 1, wherein for each portion of said display means where two or more groups are to be displayed, a group having the highest visibility priority level overlaps the other groups.

6. The apparatus according to claim 1, wherein said analyzing comprises updating an appearance of said group in response to said user activation.

7. A method of generating a user interface in a computer-implemented system comprising:
(a) defining a plurality of user-interface groups containing a plurality of user interface components;
(b) layering said groups in response to respective visibility priority levels;
(c) optimizing a location of said groups with reference to an aspect ratio of a graphical display;
(d) displaying said groups on said graphical display; and
(e) facilitating interface navigation by analyzing signals from a graphical user input to select an image processing operation in response to user activation of said user interface component.

8. The method according to claim 7, further comprising rendering at least one of said groups as transparent by combining pixel values from a plurality of said layers.

9. The method according to claim 7, further comprising moving a group in response to said user activation.

10. The method according to claim 9, wherein a group cannot be moved further than an edge of an adjacent group.

11. The method according to claim 7, wherein the displaying of said groups comprises:
identifying an area of said display where two or more groups are to be displayed;
identifying a group having the highest visibility priority level;
overlapping said identified group over said other groups.

12. The method according to claim 7, further comprising updating an appearance of said group in response to said user activation.

13. The method according to claim 7, further comprising displaying said user-interface groups so that they occupy substantially the width of said graphical display means regardless of the aspect ratio of said graphical display means.

14. A computer-readable medium having computer-readable instructions executable by a computer to perform a method of generating a user interface, the method comprising:
(a) defining a plurality of user-interface groups containing a plurality of user interface components;
(b) layering said groups in response to respective visibility priority levels;
(c) optimizing a location of said groups with reference to an aspect ratio of a graphical display;
(d) displaying said groups on said graphical display.

15. The computer-readable medium according to claim 14, wherein said method further comprises rendering at least one of said groups transparently.

16. The computer-readable medium according to claim 14, wherein said method further comprises adjusting a position of a group in response to a user interaction with said interface.

17. The computer-readable medium according to claim 16, wherein a group cannot be moved further than an edge of an adjacent group.

18. The computer-readable medium according to claim 14, wherein the displaying of said groups further comprises:
identifying an area of said display where two or more groups are to be displayed;
identifying a group having a highest visibility priority level;
overlapping said identified group over said other groups.

19. The computer-readable medium according to claim 14, wherein said method further comprises updating an appearance of said group in response to a user interface interaction.

20. The computer-readable medium according to claim 14, wherein said method further comprises displaying said user-interface groups across a width of said graphical display regardless of the aspect ratio of said graphical display.
